(19) United States
(12) Patent Application Publication
(10) Pub. No.: US 2024/0260677 A1
(43) Pub. Date: Aug. 8, 2024

(54) Heat-Not-Burn Aerosol-Generating Device Comprising a Transparent Heater

(71) Applicant: JT International S.A., Geneva (CH)

(72) Inventor: Patrick Debergh, Cressier (CH)

(73) Assignee: JT International S.A., Geneva (CH)

(21) Appl. No.: 18/682,613

(22) PCT Filed: Jul. 20, 2022
(86) PCT No.: PCT/EP2022/070391

§ 371 Date: Feb. 9, 2024

(30) Foreign Application Priority Data
Aug. 12, 2021 (EP) 21191027.8

(51) Int. Cl. A24F 40/53; A24F 40/20; A24F 40/46; G06K 7/14

(52) U.S. Cl. CPC A24F 40/53; A24F 40/20; A24F 40/46; G06K 7/1417

(57) ABSTRACT

A heater for an aerosol-generating device includes at least one portion made of a material that is, at least partially, thermally conductive and transparent to electromagnetic radiation. An aerosol-generating device includes the heater. An aerosol-generating system includes the aerosol-generating device and an aerosol-generating article inserted into the aerosol-generating device. A method for authenticating an aerosol-generating article using the device includes the steps of: collecting radiated electromagnetic radiation from an inserted article, through the at least one transparent portion, and collecting at least a portion of the radiated electromagnetic radiation by the detector of the optical reader system, and authenticating the aerosol generating article by computing information contained in the collected electromagnetic radiation by the detector.

### TECHNICAL FIELD OF THE INVENTION

The present invention relates to the field of aerosol-generating articles and devices, in particular to heat-not-burn articles and devices.

### BACKGROUND OF THE INVENTION

Electronic cigarettes and vaporizers have gained popularity in the recent years. There are mainly two types: liquid vaporizers, which produce an inhalable vapour or aerosol by heating of a liquid vaporizable substrate such as an e-liquid or gel, and heat-not-burn devices, which generate an aerosol upon heating of a tobacco containing aerosol-generating consumable article inserted in the device. Heat-not-burn systems are meant to provide a more authentic tobacco flavour and taste than flavoured liquid-generated aerosols. Their working principle is to heat a material, such as tobacco, comprising an aerosol-forming substance (such as glycerine or propylene glycol) which vaporises during heating and creates a vapour that extracts nicotine and flavour components from the tobacco material. The substance is heated to between 200 and 400° C., which is below the normal burning temperatures of a conventional cigarette. A heat-not-burn device is typically a hand-held device comprising an inner chamber, which is configured to receive consumable articles such as tobacco-rod consumables and heating means to heat the consumable article internally/or externally when the consumable article is inserted in the chamber to generate an inhalable aerosol. The heating means are electrically powered by means of a rechargeable battery arranged in the device, and both heating means and battery are electronically controlled by an electronic control arrangement comprising sensors, circuitry and often, ICs and/or microprocessors.

To ensure compatibility of a given aerosol-generating article with a given heat-not-burn device and/or authenticity of an aerosol-generating article, it has so far been proposed to provide indicia containing optical information about the article, arranged on its outer surface. Such indicia can be read by optic means upon insertion in a correspondingly designed heat-not-burn device having reading means, or through external reading, for instance using a separate reader such as a handheld terminal or smartphone. In some cases, said indicium may also contain optical information about parameters a heat-not-burn device shall be set to for proper consumption of the article, such as the ideal temperature range, or the heating profile in function of time.

In an example, described in EP3818877A1, an indicium is constituted by a thermochromic substance that is embedded in the wrapper of a smoking article. After heating by an opaque heater that surrounds at least a portion of an inserted smoking article, the color appearance of a portion of the surface of the smoking article is altered and is used to give an indication of the fact that the articles has been heated, so has been consumed, at least partially. Such altering of a color may only be visualized when the article is removed by a user and is inspected by the user or possibly by an optical inspection device.

More advanced optically readable indicia rely mostly on classic codes such as barcodes of 2D or 3D types. Other types of indicia comprise information codes that are contained in arrays of individual elements having sizes less than 100 μm or even less than 1 μm, so that the details are very difficult to observe with the unaided human eye. The individual elements may be formed of for example: ink, holes, embossing, cavities, or microstructures such as diffractive structures.

All optically readable indicia rely on the use of a light source that is fit for providing a light beam that is directed onto at least a portion of the indicia. The interaction of a light beam with an indicium provides at least one secondary light beam that may be a reflected and/or a diffracted light beam emitted by part of the indicium at least.

In devices that rely on opaque heaters, such as inductance heaters as described in the document WO2020/182767A1, optical information can only be retrieved from a portion of a smoking article that is situated outside the volume defined by the inductive heater, which limits the available space and so the possible optical arrangements that would be necessary to retrieve optical information from a smoking article.

For example, the aerosol-generating device described in WO2018/050701 A1 comprises a light source that is arranged at the periphery of the cavity of the device that receives an article, and on a support. The light source in WO2018/050701 A1 is adapted to illuminate light onto a wrapper of an article, from the periphery and thus from the outside of an article and to excite luminescent material incorporated in the wrapper of the article.

Existing heat-not-burn devices are compact devices in which it is difficult to arrange optical components, among which detectors and light sources. In the case of heaters that rely on a configuration that relies on a heater material, such as metals, that surround a smoking article, the place available on the smoking article and also in the aerosol-generating device is always very limited For example, it would not be possible to read an indicium that is integrated onto or into the portion of the wrapper that surrounds the smoking substrate to be heated. Arranging optical elements between the cavity in which the smoking article is inserted and a heater would be extremely difficult, if not impossible, to realize and reading of information would be limited to the portion of the article that does not comprise the aerosol-generating substrate, for example the filter of a smoking article, and with an optical system that is arranged at one of the extremities of the heater, and outside the heater, because the heater is opaque.

So, there is a need for an optical system that may be implemented to read information over a portion of the surface of a smoking article that is facing an optical opaque heating element of an aerosol-generating device.

### SUMMARY OF THE INVENTION

The inventors of the present invention have found solutions to the above-discussed problems by providing a heater for an aerosol-generating device that allows to transmit light to and from the surface of an aerosol-generating article without affecting the thermal properties of the heating compartment of device.

In a first aspect, the invention relates to an aerosol-generating device comprising a power supply section and a cavity arranged in an outer body part. The cavity has an opening accessible at the outer body part and is configured to receive an aerosol-generating article upon insertion of the consumable segment of said article, at least in said cavity. The aerosol-generating device further comprises a heater for an aerosol-generating device. The heater extends over a length L0 and comprises at least one transparent portion having a length L1 inferior or equal to L0, said portion being made of a material that is at least partially thermally conductive and that is, at least partially, transparent to an electromagnetic radiation. The transparent portion has a transparency value T being defined as a fraction of the intensity 11 of an electromagnetic radiation beam incident on said portion and transmitted through said transparent portion. Providing a heater that is, at least partially, transparent to electromagnetic radiation, and furthermore thermally conductive, allows to provide not only a heater that is configured to transmit a light beam from a smoking article to a detector or image, but at the same time to assure that there is no influence on the heat distribution that must be provided in a cavity to heat a smoking article. Using an aperture in a heater would influence the heat balance or required heat profile in the heating compartment of the device and would, furthermore, transmit heat outside the heating compartment, which is not acceptable in aerosol-generating devices.

In an embodiment, said transparency value T is between 10% and 90%, more preferably between 20% and 85%, even more preferably between 40% and 85%. The transparency depends on the material used for the transparent portion, the wavelength of the transmitted light and the thickness of the transparent portion. In embodiments the transparent portion may be, at least partially, transparent to a narrow wavelength range, for example a spectral range smaller than 10 nm, for example between 1500 and 1500 nm.

In an embodiment the portion is at least partially transparent to a beam of electromagnetic radiation having a wavelength between 120 nm and 1 mm, preferably between 250 nm and 15 μm, even more preferably between 350 nm and 10 μm. Providing a heater 4 that is at least partially transparent to electromagnetic radiation allows not only to detect an indicium by detecting the intensity and/or or spectral and/or or polarisation of reemitted radiation by an indicium of an article, but may also be used to realize an optical image of an indicium. In embodiments, imaging of an indicium 110 of an aerosol-generating article 100 may be combined with information related to the intensity and/or or spectral and/or or polarisation of the reemitted light by the indicium.

In an embodiment the length L1 of said portion of the heater is between 0.1×L0 and 0.3×L0 including 0.3×L0, preferably between 0.3×L0 and 0.5×L0 including 0.5×L0, more preferably between 0.5×L0 and 0.8×L0 including 0.8×L0, even more preferably between 0.8×L0 and L0, including L0.

In an embodiment the heater comprising at least two different portions transparent to an electromagnetic radiation, said two portions being arranged adjacent or separate to each other along the length L0 of the heater.

In an embodiment, the at least one portion is made of a material having a thermal conductivity greater than 200 W/(m·K), preferably greater than 500 W/(m·K), more preferably greater than 1000 W/(m·K), even more preferably greater than 2000 W/(m·K).

In an embodiment, the material of said at least one portion is chosen among: diamond, diamond-like carbon (DLC), a carbide, ZnO, SnO, glass, SiO2, Al₂O₃, a heat resistive polymer, or a combination thereof.

In an embodiment, the material of the at least one transparent portion is electrically conductive.

In an embodiment, the heater comprises at least one electrically conductive layer that may be arranged to said at least one transparent portion.

In a second aspect the invention is achieved by an aerosol-generating device comprising:
a cavity having an opening configured to receive an aerosol generating article,
a heater as described herein, arranged about the cavity to heat said aerosol generating article after insertion thereof in the cavity,
an optical reader system comprising at least one optical detector;
a power supply unit, and
a control unit configured to control at least the heater and said optical reader system.

The device is configured to collect, through said transparent portion and by said optical reader system, at least a portion of reflected or transmitted electromagnetic radiation provided by said article.

In an embodiment said at least one transparent portion extends around an entire periphery of the cavity.

In an embodiment the heater or said at least one transparent portion forms a distal end of said cavity opposite the opening.

In an embodiment said heater comprises at least one electrical conducting layer that is in electrical and/or thermal contact with an electrical or thermal power source of the device.

The invention relates also to an aerosol-generating system comprising the aerosol-generating device and an aerosol-generating article inserted, at least partially, into the aerosol-generating device.

In another aspect the invention relates to a method for authenticating an aerosol-generating article using an aerosol-generating device, the method comprising the steps of:
inserting at least a portion of the aerosol-generating article in the cavity of the aerosol generating device;
collecting radiated electromagnetic radiation from the article, through said at least one transparent portion, and collecting at least a portion of said radiated electromagnetic radiation by the detector of the optical reader system;
authenticating the aerosol-generating article by computing information contained in the collected electromagnetic radiation by the detector in said control unit.

In an embodiment the method comprises a step of emitting electromagnetic radiation by an emitter arranged in said device and directing, through said at least one transparent portion, an electromagnetic beam towards and onto said article, and wherein said collected radiation is a reflected portion of the incident electromagnetic beam onto said article.

In embodiments, collecting radiated electromagnetic radiation from the article may be used to provide an image of an indicium arranged on an aerosol-generating article in variants, imaging of an indicium of an aerosol-generating article may be combined with information related to the intensity and/or or spectral and/or or polarisation of the reemitted light by the indicium.

### BRIEF DESCRIPTION OF THE DRAWINGS

FIG. 1 shows a schematic representation of a partial longitudinal cross section of an aerosol-generating device comprising an at least partially transparent heater of the invention.

FIG. 2 shows a schematic representation of a partial longitudinal cross section of an aerosol-generating device comprising a heater that is, at least partially, transparent over its entire length.

FIG. 3 shows a schematic representation of a partial longitudinal cross section of a heater of the invention that comprises a transparent section.

FIG. 4 shows a schematic representation of a partial longitudinal cross section of a heater of the invention that is, at least partially, transparent over its entire length.

FIG. 5 shows a schematic representation of a partial longitudinal cross section of a heater of the invention that is, at least partially, transparent over its entire length, and which comprises a closed end.

FIG. 6 shows a schematic representation of a partial longitudinal cross section of a heater of the invention that comprises two opaque and two transparent sections.

FIG. 7 shows an example of a partial transparent portion of a heater. The portion here is a window arranged into a heater, the window comprising a first transparent plate and a second plate or layer that is transparent to electromagnetic light and which is thermally conductive.

FIG. 8 shows a heater that comprises a transparent and thermal conductive portion that comprises a first portion that is transparent and a second portion that is a transparent and thermal conductive layer. In the example of FIG. 8, the first portion has a prismatic shape to deflect reflected light from the smoking article. The FIG. 8 illustrates also a possible thermal bridge to assure thermal connection between the opaque portion and the transparent portion of the heater.

FIG. 9 shows an aerosol-generating system comprising an aerosol-generating device and an aerosol-generating article inserted in the device and configured to collect information from an indicium of the article by reflection of light from the indicium.

FIG. 10 shows an aerosol-generating system comprising an aerosol-generating device and an aerosol-generating article inserted in the device and configured to collect information from an indicium of the article by transmission and reflection of light from an indicium.

FIG. 11 shows a partial view of an aerosol-generating system comprising an aerosol-generating device and an aerosol-generating article inserted in the device and configured to collect information from an indicium of the article by reflection of a light beam from an indicium, the light beam being composed of at least two light beams having different spectral and/or polarization properties.

FIG. 12 illustrates a transparent and thermally conducting heater that is connected to heat source by at least one thermal conducting connection.

FIG. 13 illustrates a cylindrical shaped heater, according to the invention, comprising two thermal conducting connections which may also be electrical conducting connections.

FIG. 14 illustrates a transparent and thermal conducting portion of the heater that comprises a curved surface area that provides a focusing function for electromagnetic radiation.

FIG. 15 illustrates an aerosol-generating device comprising a heater of which at least an end portion defines a closed end portion of a heating compartment of the device.

### DETAILED DESCRIPTION OF THE INVENTION

The present invention will be described with respect to particular embodiments and with reference to the appended drawings, but the invention is not limited thereto. The drawings described are only schematic and are non-limiting. In the drawings, the size of some of the elements may be exaggerated and not drawn on scale for illustrative purposes.

Electromagnetic radiation as described herein concerns electromagnetic waves having wavelengths between 200 nm and 1 mm, i.e. extending possibly between the UV part of the electromagnetic spectrum up to and including Terahertz waves.

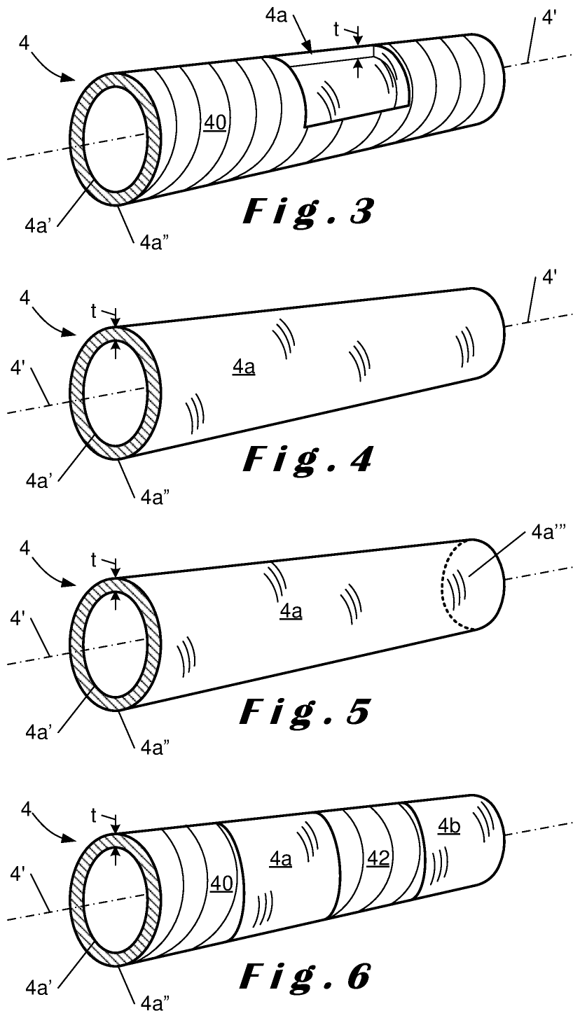

FIG. 1 represents an aerosol-generating device 100 for the aerosol-generating system according to the invention. This aerosol-generating device 100 comprises an outer body part, wherein a power supply section 250 and a cavity 2 are arranged. The cavity 2, also defined as a compartment, defines a Z-axis of insertion of an aerosol-generating article 1 and has an opening 2a accessible at the outer body part. The outer body part may include one or more air inlets (not shown), typically at the distal end 2b opposite to said opening 2a. The aerosol-generating device 1 comprises the heater 4 of the invention which embodiments are disclosed in detail herein and illustrated in FIGS. 3-6.

The aerosol generating device 1 is configured to insert an aerosol generating article 100 and forms an aerosol generating system when the aerosol generating article 100 is inserted, at least partially, into the aerosol generating device 1. The aerosol generating article 100 is a disposable article and comprises an aerosol generating substrate 110, for example tobacco, having a first end and a second end. The aerosol generating article 100 is substantially stick-or rod-shaped and has preferably a substantially circular cross-section which generally conforms to the circular cross-section of the heating compartment being the cavity 2 of the aerosol-generating device 1. The aerosol-generating article 100 typically comprises a paper wrapper (not shown in the Figures) surrounding the aerosol-generating substrate 110. The smoking article 100 comprises a filter at said first end which is the mouth end. The filter acts as a mouthpiece and comprises an air-permeable plus, for example comprising cellulose acetate fibres. Both the paper wrapper and the filter are typically overwrapped by an outer wrapper (not illustrated in the Figures), typically by a tipping paper.

The heater 4 is positioned adjacent to the cavity 2 which is the heating compartment. In operation the heater is adjacent to an outer surface of the aerosol generating substrate 110 as best seen in FIGS. 8, 9, 10, 11. The longitudinal length of the volume of the smoking article 100 that comprises the substrate 110 is not necessarily identical than the length Lo of the heater 4, it may me smaller or greater. The heater 4 has a surface which is exposed to the interior of the cavity 2 so that it can heat the aerosol-generating substrate 110. As described further, the heater 4 may extend fully or only partially around the circumference of the cavity 2. The airflow in the heating compartment is an important parameter for the efficient consumption of the smoking article. For example, if through-apertures would be present in the body of a heater it may influence the airflow and reduce the smoking efficiency, or may reduce locally the heating temperature, inducing a non-uniform consumption of the substrate 110 of the smoking article 100.

In order to retrieve information on the smoking article 100, the invention proposes a solution that allows to collect electromagnetic waves, typically visible or infrared light, from an article 100. The electromagnetic waves pass through the heater 4 of the aerosol generating device 1, and at the same time it is assured that there is no effect on the thermal profile to heat the substrate 110.

The heater 4 of the invention extends over a length L0 that is typically smaller than the length of the heating cavity 2 in the longitudinal direction Z. The heater 4 comprises at least one transparent portion 4a, 4b having a length L1 inferior or equal to L0. The at least one transparent portion 4a, 4b is made of a material that is, at least partially, thermally conductive, and at least partially transparent to an electromagnetic radiation 200, 204, 205. The transparency T of the at least one transparent portion 4a, 4b is defined as the fraction of the intensity 11 of an electromagnetic radiation beam 200 incident on said portion 4a, 4b and transmitted through said transparent portion 4a, 4b.

Transparent portions 4a, 4b, as described herein, may be as well flat or curved windows or 3D-shaped elements, or plates, or self-standing thin layers or deposited layers. Self-standing layers are layers that are fixed to another element or support by at least one border of the layer, such as a suspended membrane. As describes further, transparent portions 4a, 4b may be a stack of at least two layers.

In the case that said transparent portion 4a, 4b is not the entire heater 4, as illustrated in FIG. 3, the heater 4 comprises at least one opaque portion 40 that is opaque to electromagnetic light and that is thermally conducting. Said opaque portion 40 is opaque to electromagnetic light and is thermally conducting and may be electrically conducting. The opaque portion 40 is preferably a metallic layer such as a metallic tube. For example, in the embodiment of FIG. 3 the opaque portion 40 has a cylindrical shape comprising an aperture in which a transparent and thermal conducting window 4a is arranged. For example, the window 4a may be pressed or glued in the aperture of the opaque portion 40.

As described further in embodiments, the transparent and thermal conducting portion 4a may be composed of at least two layers that may be different layers and may be made of different materials. For example, as illustrated in FIG. 7, at least one layer 44 may be a flat or curved window and the other layer may be a thin layer 46 arranged or deposited onto that layer 44. Preferably, the thermal conductivity of the at least one transparent portion 4a, 4b if the highest to side of the heating cavity 2 when it is arranged into an aerosol-generating device 2, as for example in the arrangement illustrated in FIG. 8.

The heater 4 of the invention must not be necessarily have a cylindrical shape, but it is a preferred choice because most of available smoking articles have a cylindrical shape. In embodiments, the heater 4 may also be a rectangular plate extending in the length of the cavity 2. Using a cylindrical shaped heater allows a better uniformity of heating of the substrate 110 of the smoking article. But, a good uniformity of heating may also be provided by arranging for example at least 3 parallel rectangular shaped heaters (not illustrated) at the circumference of a cavity. In such a case the heater 4 of the aerosol-generating device 1 is the ensemble of the 3 heater plates, and at least one of the heater plates comprises said at least partially transparent portion 4a, 4b.

Providing a heater 4 that is at least partially transparent to electromagnetic radiation allows not only to detect an indicium by detecting the intensity and/or or spectral and/or or polarisation of reemitted radiation by an indicium of an article, but may also be used to realize an optical image of an indicium 120. In a variant, imaging of an indicium 120 of an aerosol-generating article 100 may be combined with information related to the intensity and/or or spectral and/or or polarisation of the reemitted light by the indicium 120. It is understood that an indicium 120 may by any structure, element or substance that is arranged onto or into an aerosol-generating article 100. An indicium 120 is defined herein broadly in that sense that it may be provided by electromagnetic properties of the materials or components or compositions of a smoking article 100, such as the spectral characteristics of a paper wrapper or of the substrate 110.

The heater 4 of the invention is configured to transmit a light beam from a smoking article 100 to a detector 30 or imager 30 and assures at the same time that there is no influence on the heat distribution in the cavity 2 when the aerosol-generating substrate 110 of the smoking article 100 is heated in operation.

A heater 4 preferably withstands at least a temperature of 300° C. and must have a high thermally conductivity and be at least partially transparent in the UV, and/or visible and/or infrared and/or terahertz region of the electromagnetic spectrum. In preferred arrangements of an aerosol-generating devices 1, visible or infra-red light is used to detect indicia.

The term “withstand at least 300° C.” means that its mechanical, and optical properties do not change up to at least 300° C. More precisely, there should be no notable change of the index of refraction, transmission, nor any surface or volume alteration. For example, the transparent portion 4a, 4b should remain transparent to a transmitted light beam at room temperature and the transmitted light beam not be altered into a scattered light beam.

Optionally, but not necessarily, at least a portion of the heater 4 may be electrically conductive, as commented further.

The transparency T of the at least one transparent portion 4a, 4b may be any value between 0 and 100%, excluding 0. Transparencies as defined herein include the reflection losses at the surfaces of the transparent portions 4a, 4b. Reflection losses may be high for high refractive index materials, but these may be reduced considerably by applying anti-reflection coatings. The transparency T depends on the nature of the material, its possible incorporated dopants, its thickness t and the wavelength of the transmitted light through said portions 4a, 4b. The at least one transparent portion 4a, 4b must not necessarily be a highly transmitting layer or window, because low light intensities may be detected by very sensitive detectors 30. So, transmittances T of less than 10% or even less than 1% may be used. In preferred embodiments, said transparency value T is between 10% and 90%, more preferably between 20% and 85%, even more preferably between 40% and 85%.

Materials, wavelengths, and thicknesses t may be chosen to achieve a pre-set intensity transmittance T. For example, in embodiments the material may be chosen so that a predetermined transmittance T, for example 60-85%, is achieved for a given thickness and a given wavelength range. In other cases, the thickness t may be chosen so that a predetermined transmittance T, for example 60-85%, is achieved for a given material and a given wavelength range.

In an embodiment, the transparent portion 4a,4b is at least partially transparent to electromagnetic radiation 200, 204, 205 having a wavelength between 120 nm and 1 mm, preferably between 250 nm and 15 μm, even more preferably between 350 nm and 10 μm.

In an embodiment, the length L1 of said portion 4a of the heater is between 0.1×L0 and 0.3×L0 including 0.3×L0, preferably between 0.3×L0 and 0.5×L0 including 0.5×L0, more preferably between 0.5×L0 and 0.8×L0 including 0.8×L0, even more preferably between 0.8×L0 and L0, including L0.

In embodiments said at least one transparent portion 4a, 4b may have a different thickness than the thickness of the opaque portion of the heater. Such an example is illustrated in FIG. 8 and is commented further herein.

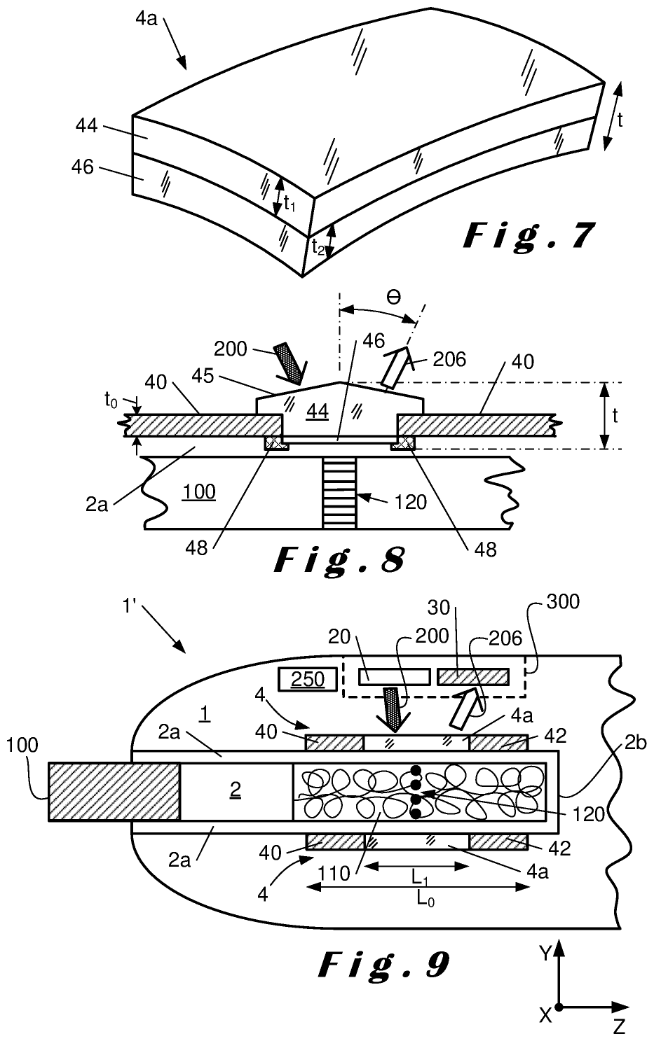

In an embodiment, the heater 4 comprises at least two identical or different portions 4a, 4b that are both at least partially transparent to an electromagnetic radiation. Said two portions 4a, 4b may be arranged adjacent may be separated by a gap or a gap layer. In the embodiment illustrated in FIG. 6 the heater 4 is an arrangement of 4 rings or tubes 40, 4a, 42, 4b. In such an arrangement the gap layer is an opaque and thermal conducting layer 42 that separates two transparent portions 4a, 4b.

In embodiments the opaque and thermal conducting portions 40, 42 are electrical conducting, and preferably made of a metal such as aluminium. In all embodiments of the invention, all the portions 40, 42, 4a, 4b of the heater 4, or the entire heater 4, may be made of:
good thermal conductors and good electrical conductors;
good thermal conductors and bad electrical conductors;
bad thermal conductors and good electrical conductors;
bad thermal conductors and bad electrical conductors;

Herein, good thermal conductors are defined as having a thermal conductivity equal or greater than 500 W/(m·K) and bad thermal conductors are defined as having a thermal conductivity smaller than 500 W/(m·K). Good electrical conductors are defined herein as being made of a material having a resistivity equal or smaller than 2.8×10⁻⁸ Ωm (ohmmeter) and bad electrical conductors are defined as having a conductivity greater than 2.8×10⁻⁸ μm.

Preferred choices for the transparent portions 4a, 4b are materials that present good thermal conductors that are also good electrical conductors. In variants, the thermal and/or electrical properties of the opaque portions 40, 42 of the heater 4 and the transparent portions 4a, 4b may be different. Also, in variants, the transparent and heat-conducting portions 4a, 4b must not have necessarily homogeneous optical and/or thermal properties. For example, one side of said at least one transparent portion 4a, 4b may have a greater thermal conductivity than its opposite side. In such a case, the side having the greatest thermal conductivity is arranged in a device 1 to the side of the cavity 2.

In an embodiment, the at least one portion 4a, 4b is made of a material having a thermal conductivity greater than 200 W/(m·K), preferably greater than 500 W/(m·K), more preferably greater than 1000 W/(m·K), even more preferably greater than 2000 W/(m·K).

There are only a limited number of materials that may suite to realize the at least one transparent portion 4a, 4b, of the heater 4, because of the combined requirement of transparency and thermal conductivity. Preferred choice of such materials are now described.

The transparent portion 4a of the heater 4 may be made of a single material or it may be a transparent and thermal conducting layer arranged on a transparent dielectric substrate or window that is not or only partially thermally conducting as described further in embodiments.

In an embodiment, the material of said at least one portion 4a, 4b is chosen among: diamond, diamond-like carbon (DLC), a carbide, ZnO, SnO, glass, SiO2, Al2O3, a heat resistive polymer, or a combination thereof. The material of said at least one portion 4a, 4b may be doped materials and must not be necessarily homogeneous materials.

Optical properties of materials of the transparent portions 4a,4b as described herein may be found in, for example: W. G. Driscoll, “Handbook of Optics»; Optical Society of America, Mc-Graw-HILL book company, 1978, ISBN 0-07-047710-8, 7.1-17.24.

Preferred materials, as described further, are carbon-based materials such as synthetic diamond. For such materials for example, a transmission T of more than 60% may be achieved for thicknesses t up to 3 mm and for visible or near-infrared wavelengths.

In an embodiment, the material of the transparent portion 4a is a non-doped diamond layer or window or thin film. Diamond is five times better at conducting heat than copper. Unlike most electrical insulators, diamond is a good conductor of heat because of the strong covalent bonding and low phonon scattering. Thermal conductivity of natural diamond is about 2200 W/(m·K), i.e. 22 W/(cm·K), which is five times more than copper the most thermally conductive metal. Monocrystalline synthetic diamond enriched to 99.9% the isotope 12C has an extremely high thermal of about 3320 W/(m·K). The electrical resistivity of most diamonds is on the order of 1011 to 1018 Ω·m.

In embodiments, the at least one transparent portion 4a, 4b of the heater 4, or the whole heater 4, is made, at least partially, of doped diamond, preferably doped synthetic diamond. Synthetic diamond layers or windows as described herein may be realized by any technology such as Plasma Enhanced Chemical Vapor Deposition (PECVD) or Chemical Vapor Deposition (CVD), or a High Temperature-High Pressure (HTHP) process. The realisation of synthetic diamond is described in for example the following publication that is incorporated herein in its entirety: R. S. Balmer et al.,” Chemical vapour deposition synthetic diamond: materials, technology and applications, Journal of Physics Condensed Matter, August2009, pp. 1-51, DOI 10.3762/bjnano.11.57.

In embodiments, illustrated in FIG. 7, the entire heater 4, or a transparent portion 4a, 4b of the heater 4 may be made of a stack of layers comprising at least two layers 44, 46. The stack may be realized by a plate on which at least one layer is arranged, such as a deposited layer. FIG. 7 shows an example of a partial transparent and composite portion 4a of a heater 4. The portion 4a in FIG. 7 is a window arranged into a heater. The window comprises a first transparent plate and a second plate or layer 46 that is transparent to electromagnetic light and which is thermally conductive.

For example, at least one transparent portion 4a, 4b of the heater 4 may comprise a transparent dielectric substrate 44 made of for example glass, SiO2, sapphire or a heat resistive polymer withstanding at least 250° C. In such a case another window or layer 46 is arranged on that substrate 44 to assure that the transparent portion 4a, 4b may be heat conducting, at least to the side that must be arranged, in a device, to the circumference of the cavity 2.

The second layer may be any transparent and heat conducting nano- or micrometer thick layer such as a layer of doped synthetic diamond, a doped semiconductor layer. Said second layer may be a stack of at least two layers. The second layer may be partially be arranged on the adjacent opaque layer 40 so as to make a direct thermal contact with it. The first and second transparent layers 44, 46 may be bonded and/or curved layers.

In embodiments, as illustrated in FIG. 8 a transparent portion 4a comprises a prismatic shaped transparent basis plate 44 to which a transparent and heat conducting layer 46 is deposited. Said basis plate 44 may be made, for example, in SiO2 or A₂O3. To assure thermal contact of the transparent portion 4a, 4b with the opaque and thermal conduction part 40, 42 of the heater 4, a thermal bridge layer 48 may be arranged between or onto the thermal conducting part 40 and said heat conducting layer 46. A thermal bridge 48 is made of a heat conducting layer, possibly a metallic layer or a plurality of heat-conducting contacts.

In an embodiment, the at least one portion 4a, 4b may comprise a metallic doped DLC layer. Doping of DLC films is possible with many different metals including at least one of: Ti, Nb, Ta, Cr, Mo, W, Ru, Fe, Co, Ni, Al, Cu, Au, Ag. The advantage of Metal doped -DLC layers or plates is that their conductivity behaviour can be varied from those of dielectric to those of metallic materials. Metals may be be incorporated in the layers 4a, 4b, 44, 46 as small nanocrystallites of pure metal or metal carbide parts, which are dispersed throughout the carbon network.

In an embodiment, the at least one transparent portion 4a, 4b is made, at least partially, of Boron and/or phosphorous Doped Diamond (BDD, PDD). The conductive limitations of diamond in the past are no longer a problem today. The insertion of foreign atoms into the crystalline structure of diamond can decrease the large energy gap to an acceptable level to allow the electrical conduction but keep their thermal and chemical stability properties. Boron, nitrogen, and phosphorus are the most common foreign atoms that can be added to diamond that may be synthetic diamond. BDD has become the more popular material of synthetic diamond since its introduction in 1987.

It is to be noted that, in embodiments, synthetic diamond windows or layers 4a, 4b, 44, 46 doped with boron (BDD) are p-type semiconductors. Also, Phosphorus-doped diamond (PDD) windows or layers (PDD), produced by chemical vapor deposition, are n-type semiconductors.

Alternating boron-doped and phosphorus-doped layers produce p-n junctions and may be exploited to provide advantageous embodiments of the heater 4. For example, such layers may be used to produce ultraviolet emitting light emitting diodes (LEDs). For example, in an embodiment, the heater 4 may comprise at least one transparent portion 4a that comprises an alternating boron-doped and phosphorus-doped layer stack which allows to integrate, into or onto the heater 4, a LED light source.

In a variant, the transparent portion 4a, 4b comprises, at least, a portion made of an electro-optical or an electro-magnetic material.

In embodiments a transparent portion 4a, 4b may be realized by using a silicon support or substrate and may be used for wavelengths greater than 1.5 μm as Silicon is transparent above a wavelength of 1.5 μm. This allows to realize for example DLC layers deposited on said silicon substrate, the technology of which is well known in the field of MEMS. In embodiments a free-; standing membrane 4a, 4b may be realized on a silicon frame so that a transparent portion 4a, 4b may be realized by a batch process and provide a cheap solution. A silicon frame may, for example, also be easily bonded to the opaque part 40 of a heater 4.

In embodiments (not illustrated), the at least one transparent portion 4a, 4b may be made of a self-standing layer, possibly a flexible layer, arranged on a through-aperture provided in the opaque portion 40 of the heater 4. A length of such a flexible transparent portion 4a, 4b may be arranged in thermal contact with the opaque portion 40, possibly by a mechanical force or by gluing or by soldering, or by any process that implies a deposition process such as known in the realisation of membranes.

The at least one transparent portion 4a, 4b, of the invention may have any shape such as:
a cylindrical shape, not necessarily having a uniform diameter over its length;
the shape of a closed or open ring;
a tube or ring having a rectangular or square-shaped cross section or any other non-circular cross-section,
a flat or curved plate having at least one rectangular shaped cross-section;
a window having at least two cross-sections that have different curvatures,
a window having at least one flat side and at least one curved side;
a ball or a hollow sphere;
a shape defined by at least two inclined planes such as a prismatic shape illustrated in FIG. 8;
an array of transparent and thermal conductive windows, that may be an array of micro lenses or microprisms.

For applications of imaging of an indicium 120, flat shaped, or only slightly curved transparent portions 4a, 4b are preferred choices. In variants wherein the detection and recognition of indicia 120 are only based on the measurement of intensity, and/or spectral and/or polarisation variants, the shape of the at least one transparent portion 4a, 4b is less restrictive. For example, a transparent portion 4a, 4b may have the shape of a ball or a cube that allows to transmit, to a detector 30, light to and from an indicium 120.

The heater 4 may be a self-heating device if it is doped. It may also be heated by a thermal conducting layer or contact, possibly by using deposited conductive strips 500, 502 as illustrated in FIG. 13. Self-heating herein means that the heater 4 may be heated by an electrical current provided through the heater body.

In an embodiment, the material of the at least one transparent portion 4a, 4b is electrically conductive and presents an electrical resistance that allows to heat the body of the heater 4. In such an embodiment the heater 4 may be heated directly by applying an electrical voltage over at least a portion of the heater 4, so inducing heat through the Joule effect of the provided electrical current inside the body of the heater 4. This allows to avoid an additional electrical heating element 400 that must be in thermal contact with the heater, so it simplifies the design of the heater 4.

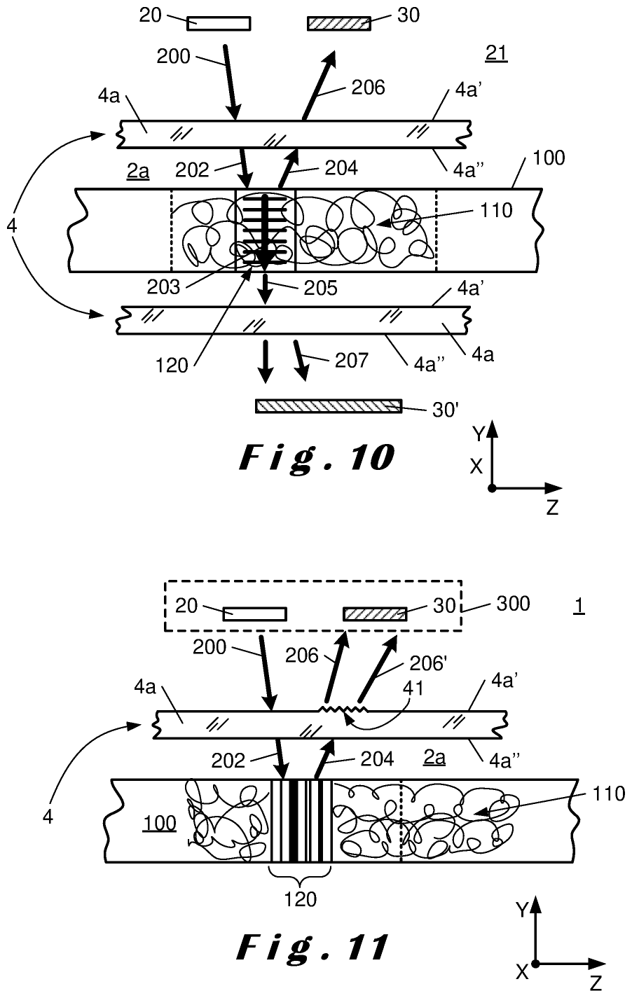

In advantageous variants, illustrated in FIG. 10, the heater 4 may comprise passive or active optical elements or device that are arranged to said at least one transparent portion 4a, 4b.

In another variant, not illustrated, a transparent portion may consist in two abutted portions 4a, 4b that may be two abutted rings that may have different optical properties, such as different transparencies in function of the wavelength of the transmitted light and/or its polarisation state or polarisation direction. This allows to provide transparent portions that may comprise optical filtering. For example, one part may transmit a light beam having a broad spectral range towards an indicium and the light may be filtered by said second portion to provide, to a detector only a portion of a light beam that has a narrower spectrum than the incident light onto the wrapper of a smoking article.

In an advantageous embodiment, at least one side 4a′, 4a″ of said at least one transparent portion 4a, 4b is a curved convex or concave surface. This allows to provide a focusing or diverging optical function to said at least one transparent portion 4a, 4b. In a variant, illustrated in FIG. 13, the at least one transparent portion 4a, 4b may comprise a flat portion 4a′″ and another portion 4a″ that is curved. Such an arrangement may be used to illuminate uniformly a predetermined area of an area of an article, that comprises preferably an indicium 120, and to collect efficiently reflected or scattered light by said curved portion 4a″, which allows to collect a greater optical power by a detector or imager while at the same time to avoid to have to adapt a lens to said at least one transparent portion 4a, 4b.

In yet another advantageous embodiment, said at least one transparent portion 4a, 4b may comprise, on at least one of its surfaces or inside the transparent portions 4a, 4b a substance which color is modified, or which generates light, under the action of the change of a physical parameter such as heat, or an electrical current or an electrical field. For example, the at least one transparent portion 4a, 4b comprises, or may be coated by, a fluorescent substance.

In embodiments said static optical elements may be, without limitations:
optical filters;
optical coatings that may be anti-reflections coatings or coatings that have a specific spectral absorption for predetermined wavelengths of transmitted light through the at least one transparent portion 4a, 4b;
an opaque plate or film comprising an aperture such as a slit, which may serve to limit the field of view. In a variant, two apertures may be provided, i.e. one to transmit light to the article 1 and one to transmit light from the article to a detector. The aperture may be an array of more than 2 apertures;
an optical lens and/or or an optical mirror;
an array of microlenses and/or an array of microprisms;
a polarizer;
diffractive elements or diffractive structures. FIG. 10 illustrates a variant wherein the optical element is a diffractive optical structure 43 or layer. The diffractive structure may be realized by embossing the transparent layer 4a, to at least one of its sides 4a′, 4a″. Diffractive structures as illustrated in FIG. 11 allows to provide simple solutions to split an incident light beam 204 in at least tow different light beams 206, 206′.
a half-or quarter-wave plate;
a particular shape of the surface of the transparent layer 4a. FIG. 8 illustrates a prismatic shaped surface 45 of the substrate 44 of the transparent layer, and allows to provide a deviating optical function as illustrated by a deviation angle θ of the light beam provided by an indicium 120 or the area of the smoking article 100 on which it is arranged

In embodiments, said active optical elements (not illustrated) may be, without limitations:
an optical addressable modulator. In variants the modulator may be an addressable optical shutter, such as a MEMS shutter;
an electro-optical layer that may be addressed to modify the polarisation state and/or polarisation direction of the incident or reflected light respectively sent to and from the surface of a smoking article.
an addressable mirror that may be a MEMS mirror. The mirror may be used to close optically said at least one transparent portion 4a, 4b in its closed position, i.e. the mirror surface being parallel to the transparent window 4a, 4b. The mirror may be addressed and direct light, provided by the smoking article 110 or its indicium 120, to a detector 30 according to a pre-set angle. In variants the addressable mirror may direct light, in operation of the device, light to two different detector elements according to at least two different angles. This allows for example that optical information may be retrieved from two different areas of the smoking article.

The invention is also achieved by an aerosol-generating device 1 that comprises:
a cavity 2 having an opening 2a configured to receive an aerosol generating article 100,
a heater 4, as described herein, arranged about the cavity 2 to heat said aerosol generating article 100 after insertion thereof in the cavity 2,
an optical reader system 300 comprising at least one optical detector 30,
a power supply unit, and
a control unit 250 configured to control at least the heater 4 and optical reader system 300

The device 1 of the invention is configured to collect, through said transparent portion 4a, 4b and by said optical reader system 30, at least a portion 206, 207 of reflected or transmitted electromagnetic radiation 204, 205 provided by said article 100.

In the device 100 of the invention, a light source 20, is preferably used to illuminate an indicium 120 of an article 100. In variants the light source 20 may be electromagnetic radiation, such as infrared radiation, that is provided by a heat source or the heater 4 itself.

In an embodiment, the at least one transparent portion 4a, 4b extends around an entire periphery of the cavity 2. In variants, the at least one transparent portion 4a, 4b may be composed by a plurality of transparent portions that may be arranged as a series of separate rectangular shaped window portions at the periphery of the cavity 2.

In embodiments, the heater 4 may extend fully or only partially around the circumference of the cavity 2. In embodiments for example, the heater 4 may extend between one-tenth and three-quarters of the circumference. The heater 4 may comprise at least two separate heating elements, for example two heating elements that extend each about 45 degrees of the circumference of the cavity 2.

In an embodiment, said heater 4 comprises at least one electrical conducting layer 400 that is in electrical and/or thermal contact with an electrical or thermal power source arranged in the aerosol-generating device 1. For example, FIG. 11 illustrates a transparent and thermally conducting heater that is connected to heat source 400 by at least one thermal conducting connection 402, 404. In variants, the conducting connection 402, 404 may be arranged to the opaque portion 40, 42 of the heater 4 or to at least one of its transparent portions 4a, 4b.

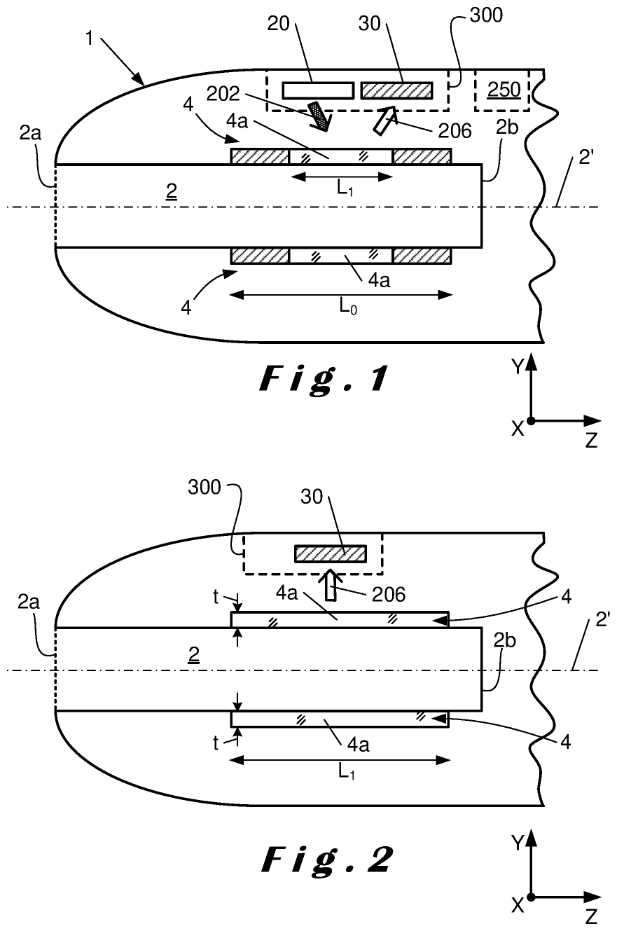

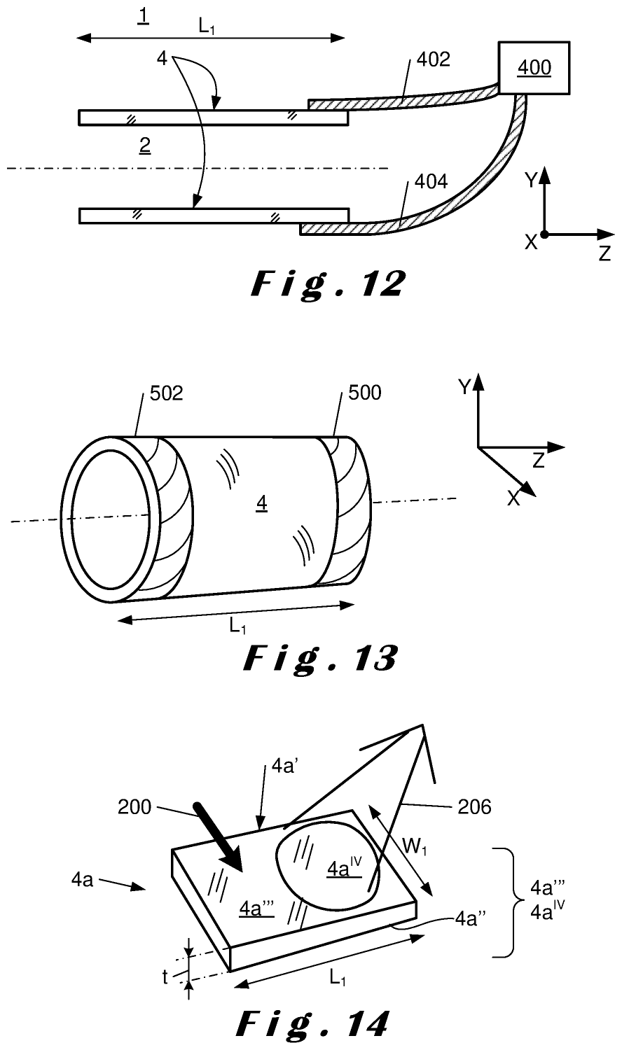

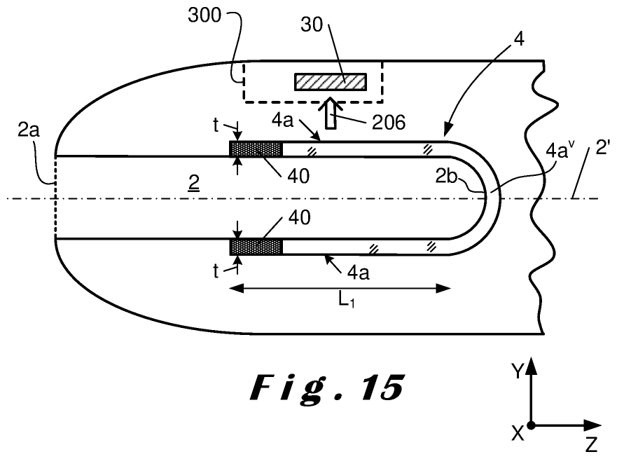

It is understood that the shape of the heater 4 is not limited to the arrangements shown in FIGS. 1-14. The heater may be configured so that it defines substantially the whole heating compartment, or at least a substantial fraction of it. For example, FIG. 15 illustrates an aerosol-generating device comprising a heater 4 of which at least an end portion 4a^{v} defines a closed end 2b of a heating compartment of the device. In variants, the closed end portion 4a^{v} may comprise at least one aperture to assure, in operation, a desired airflow. In variants, said end portion 4a^{v} may constitute an transparent portion 4a as described herein. This may allow to retrieve information from an end section of an article 100. It is also understood that said detector 30 must not necessarily face a transparent portion 4a and that for example a light beam may be directed from an indicium to the detector by using optical elements such as mirrors, lenses or waveguides.

The invention relates also to an aerosol-generating system comprising the described aerosol-generating device 1 and an aerosol generating article 100 that is inserted, at least partially, into the cavity 2 of the aerosol-generating device 1.

In another aspect, the invention relates to a method for authenticating an aerosol-generating article 100 using a device 1 as described herein, and comprises the steps of:
inserting at least a portion of the aerosol-generating article 100 in the cavity 2 of the aerosol generating device 1;
collecting radiated electromagnetic radiation 204, 205 from the article 100, through said at least one transparent portion 4a, 4b, and collecting at least a portion 206, 207 of said radiated electromagnetic radiation 204,205 by the detector 30 of the optical reader system 300;
authenticating the aerosol generating article 1 by computing information contained in the collected electromagnetic radiation 206, 206′, 207 by the detector 30 in said control unit 250.

In an embodiment, the method comprises a step of emitting electromagnetic radiation 200 by an emitter 20 arranged in said device 1 and directing, through said at least one transparent portion 4a, 4b, an electromagnetic beam 200 towards and onto said article 100, and wherein said collected radiation is a reflected portion 204 of the incident electromagnetic beam 202 onto said article 100.

In an embodiment, not illustrated, collecting radiated electromagnetic radiation from the article 100, may be realized through said end portion 4a^{v}. This allows to detect information provided by the end section 102 of an inserted article 100 in the cavity 2.

1. A heater for an aerosol-generating device, said heater extending over a length L0, wherein said heater comprises at least one portion having a length L1 inferior or equal to the length L0, said at least one portion being made of a material that is at least partially thermally conductive and at least partially transparent to an electromagnetic radiation, having a transparency value being defined as a fraction of an intensity of an electromagnetic radiation beam incident on said at least one portion and transmitted through said at least one portion.

2. The heater according to claim 1, wherein said transparency value is between 10% and 90%.

3. The heater according to claim 1, wherein the at least one portion is at least partially transparent to an electromagnetic radiation having a wavelength between 120 nm and 1 mm.

4. The heater according to claim 1, wherein the length L1 of said at least one portion of the heater is between 0.1×L0 and 0.3×L0 including 0.3×L0.

5. The heater according to claim 1, wherein the at least one portion includes at least two different portions transparent to an electromagnetic radiation, said at least two different portions being arranged adjacent or separate to each other along the length L0 of the heater.

6. The heater according to claim 1, wherein the material of the at least one portion has a thermal conductivity greater than 200 W/(m·K).

7. The heater according to claim 6, wherein the material of said at least one portion is: diamond, diamond-like carbon, a carbide, ZnO, SnO, glass, SiO2, Al2O3, a heat resistive polymer, or a combination thereof.

8. The heater according to claim 1, wherein the material of the at least one portion is electrically conductive.

9. The heater according to claim 1, further comprising at least one electrically conductive layer.

10. An aerosol-generating device comprising:
a cavity, and having an opening configured to receive an aerosol generating article,
the heater according to claim 1 arranged about the cavity to heat said aerosol generating article after insertion thereof in the cavity,
an optical reader system comprising at least one optical detector,
a power supply unit, and
a control unit configured to control at least the heater and the optical reader system,
wherein the device is configured to collect, through said at least one portion and by said optical reader system, at least a portion of reflected or transmitted electromagnetic radiation provided by said article.

11. The aerosol-generating device according to claim 10, wherein said at least one portion extends around an entire periphery of the cavity.

12. The aerosol-generating device according to claim 10, wherein said at least one portion forms a distal end of said cavity opposite the opening.

13. The aerosol-generating device according to claim 10, wherein said heater further comprises at least one electrical conducting layer that is in electrical and/or thermal contact with an electrical or thermal power source of the device.

14. A method for authenticating an aerosol-generating article using the device according to claim 10, comprising the steps of:
inserting at least a portion of the aerosol-generating article in the cavity of the aerosol generating device;
collecting radiated electromagnetic radiation from the article, through said at least one portion, and collecting at least a portion of said radiated electromagnetic radiation by the at least one optical detector of the optical reader system;
authenticating the aerosol generating article by computing information contained in the collected electromagnetic radiation by the at least one optical detector in said control unit.

15. The method for authenticating according to claim 14, further comprising a step of emitting electromagnetic radiation by an emitter arranged in said device and directing, through said at least one portion, an electromagnetic beam towards and onto said article, and wherein said collected radiation is a reflected portion of the incident electromagnetic beam onto said article.

16. The heater according to claim 1, wherein said transparency value is between 40% and 85%.

17. The heater according to claim 1, wherein the at least one portion is at least partially transparent to an electromagnetic radiation having a wavelength between 350 nm and 10 μm.

18. The heater according to claim 1, wherein the length L1 of said at least one portion of the heater is between 0.8×L0 and L0, including L0.

19. The heater according to claim 1, wherein the material of the at least one portion has a thermal conductivity greater than 2000 W/(m·K).
